(19) United States
(12) Patent Application Publication
(10) Pub. No.: US 2005/0016673 A1
(43) Pub. Date: Jan. 27, 2005

(54) Film lamination process

(76) Inventors: Michael Krebs, Hilden (DE); Uwe Franken, Dormagen (DE); Horst Hoffmann, Kirchheim (DE)

Correspondence Address: HENKEL CORPORATION, THE TRIAD, SUITE 200, 2200 RENAISSANCE BLVD., GULPH MILLS, PA, 19406, US

(21) Appl. No.: 10/888,248

(22) Filed: Jul. 9, 2004

Related U.S. Application Data
(63) Continuation of application No. PCT/EP03/00069, filed on Jan. 7, 2003.

(30) Foreign Application Priority Data
Jan. 14, 2002 (DE) 102 01 190.7

(51) Int. Cl. B32B 31/00

(52) U.S. Cl. 156/275.7; 156/272.6

(57) ABSTRACT

A film containing a polymer such as polyvinyl chloride is rapidly and reliably bonded to a molding containing a polymer, wood or aluminum using a hot-melt adhesive by thermally activating the film by heating using electromagnetic radiation.

This application is a continuation under 35 USC Sections 365(c) and 120 of International Application No. PCT/EP03/00069, filed 7 Jan. 2003 and published 15 May 2003 as WO 03/0040249, which claims priority from German Application No. 10201190.7, filed 14 Jan. 2002, each of which is incorporated herein by reference in its entirety.

### FIELD OF THE INVENTION

The invention relates to a process for the lamination of single- or multilayer surface films based on polymers with a glass transition temperature above 50° C. to moldings composed of polyvinyl chloride (PVC), of polypropylene, of acrylonitrile-butadiene-styrene copolymers (ABS), or wood, or aluminum, and also to the use of these laminated moldings.

### DISCUSSION OF THE RELATED ART

A colored or patterned surface film is frequently applied to the surface of articles, e.g., window profiles, doors, racks, furniture, plastics casings, wood, timber materials, metals, or similar materials, in order firstly to protect the surface of the articles from damaging effects, e.g., corrosion, discoloration by light or mechanical action. Another reason for the application of the surface film can be to make the surface of the article more attractive.

By way of example, use of an appropriately patterned film can create the perception of high-quality wood even when the visual quality, structure, surface, or color of the actual material used would make it unsuitable for this type of use. A surface film applied in this way is thus intended to protect the surface of the article from environmental effects such as the action of water, moisture, temperature changes or light, in particular sunlight, or else from environmental pollutants present in air.

Plastics profiles, in particular profiles composed of thermoplastics, such as polyvinyl chloride (PVC), polypropylene (PP), acrylonitrile-butadiene-styrene copolymers (ABS), have become widely used in the construction of windows and doors because they are easy to produce by the extrusion process, and are inexpensive and have good performance characteristics, whether in the form of solid, hollow, or core profiles. If PVC is used here, the PVC used may be either plasticized or semirigid, or in particular rigid PVC. The surface films used comprise either PVC films, CPL films (continuous pressure laminates) and HPL films (high pressure laminates), (printed) paper, veneer, or other sheet products, the thickness of which is generally from 0.1 to 1.0 mm. For the outdoor sector, the films proposed for the lamination process are increasingly relatively new films particularly resistant to weathering and to light. These are in particular films based on (meth)acrylates, in particular mixtures of different poly(meth)acrylate homo- and copolymers. An advantage of the use of poly(meth)acrylate films is that it is easy to produce films of different hardness levels (from brittle and hard to highly flexible) via suitable selection of the comonomers. Another advantage is that these films can be pigmented by using normal high-lightfastness organic pigments, or else iron-, chromium-, or nickel-containing pigments.

The good weathering resistance and UV resistance of these poly(meth)acrylate films is known. Recently, surface films designed as multilayer films have been proposed for further improvement in resistance to light and to weathering. For example, EP-A-343491 proposes multilayer films composed of a (meth)acrylate base film with a glass-clear polyacrylate outer film and with another glass-clear protective film composed of polyvinylidene fluoride (PVDF) or polyvinyl fluoride (PVF).

These single- or multilayer surface films based on acrylates or on methacrylates have excellent resistance to light and to weathering, but long-lasting weather-resistant adhesive bonding of these films to the abovementioned materials composed of thermoplastic polymers, wood, aluminum, and the like has been difficult to achieve, particularly because these films based on (meth)acrylates have high stiffness and during cooling of the adhesive bond exert very powerful tensile stress on the bonded joint as a consequence of high recovery forces immediately after the adhesive-bonding process. Efficient manufacturing processes require high initial bond strength of the adhesive bond after a very short time, together with even greater final strength and ageing resistance of the adhesive bond.

Many hot-melt adhesives do not adequately meet these requirements for flexurally stiff (meth)acrylate films, using conventional jointing methods.

### SUMMARY OF THE INVENTION

In the light of this prior art, it was an object of the inventors to provide a lamination process which in particular improves the adhesive bonding of single- or multilayer surface films based on polymers with a glass transition temperature above 50° C. The inventive solution of the object is found in the claims.

It substantially consists in the provision of a process for the lamination of single- or multilayer films based on polymers with a glass transition temperature above 50° C. to moldings composed of thermoplastic polymers, of wood, of timber materials, or of metals, and comprising the following manufacturing steps:
thermal activation of the film via heating with electromagnetic radiation,
application of the adhesive to the film surface,
attaching the film to the molding, where appropriate pressing the film onto the molding.

### DETAILED DESCRIPTION OF CERTAIN EMBODIMENTS OF THE INVENTION

It can be advantageous for a pretreatment of the film with a cleaning agent to take place prior to the thermal activation of the film, and where appropriate the film can then be further pretreated via a corona treatment, or the corona treatment may replace the abovementioned cleaning step. Application of a primer (adhesive promoter) to the film surface may also follow. Where appropriate, the cleaning agent and/or the corona treatment of the film may be omitted if a primer is used. Where appropriate, the molding surface, too, has to be subjected to pretreatments prior to attaching the film to the molding. Similarly to the above description, these pretreatments may be a primer application, a treatment with a cleaning agent, where appropriate followed by air drying to remove the volatile constituents, and the latter may be accelerated by supplying heat.

It can also be necessary to activate the molding surface via corona treatment or via flame application, instead of the abovementioned treatments, or together with these. The pretreatment measures for the molding surface here depend on the materials of which the molding is composed.

Widely used moldings are composed of polyvinyl chloride, or of polypropylene, of acrylonitrile-butadiene-styrene copolymers (ABS), wood, timber materials, or aluminum. Timber materials are materials mainly composed of wood or of timber-based raw materials, and among these by way of example are laminated wood, plywood, veneer sheet, laminated board, blackboard, batten board, and wood-core plywood, wood-fiber board, wood-particle board, and densified wood. Molding surfaces composed of thermoplastics in particular often require a surface pretreatment here, because these surfaces often comprise constituents which inhibit adhesion, deriving from the shaping process.

The cleaning agent described in WO 99/46358 can be used for adhesion-promoting surface-pretreatment of the molding surfaces or of the surface films. The cleaned plastics surfaces here may also be subjected to another mechanical, physical, chemical or electrochemical pretreatment prior to adhesive bonding. This may in particular be an application of an adhesion promoter or primer, e.g., as mentioned above, or pretreatment may be undertaken via flame application or via a corona treatment.

Corona treatment of plastics surfaces to be adhesive-bonded is well known, and by way of example EP 0 761 415 A2 (Agrodyn Hochspannungstechnik GmbH; the United States counterpart of which is U.S. Pat. No. 5,837,958) proposes passing a focused plasma jet across the surface. Reference is particularly made here to the pretreatment of plastics films. The surfaces mentioned for treatment comprise plastics in general, highly fluorinated polymers, e.g., PTFE, and metal surfaces, e.g., aluminum.

The plasma jet mentioned is generated by injecting an operating gas, in particular air, at atmospheric pressure and standard temperature through an electric arc. The “plasma jet” is obtained when the operating gas emerges from the arc. It is uncertain here whether the material is actually a plasma in the true sense, namely a gas at least to some extent split into ions and electrons. However, a significant feature here is that this jet is suitable for the pretreatment of plastics surfaces.

Instead of the focused plasma jet mentioned, which to a substantial extent permits pretreatment of one point on the surface, it is also possible to use a large number of plasma jets arranged in a circle, rotating around the centre of the circle (DE 298 05 99 U1). This method gives an annular plasma jet which can rapidly pass over and therefore pretreat a relatively large surface.

The adhesion-promoting primers used may comprise solvent-containing primers known per se, but preferably aqueous primers, these being described by way of example in DE-A-19826329.

However, better and more rapid adhesive bonding results are achieved for the abovementioned surface film based on (meth)acrylate base films and on similar flexurally stiff films where the glass transition temperatures of the underlying polymers or copolymers are from 50 to 130° C., in particular from 60 to 100° C., if the surface film is thermally activated with the aid of electromagnetic radiation.

Suitable electromagnetic radiation is in principle any non-ionizing electromagnetic radiation, and IR radiation may preferably be used here, in particular near-infrared (NIR) radiation in the wavelength range from 0.7 to 1.5 μm. The sources in preferred embodiments here should be capable of rapid adaptation to the activation requirements via substantially inertia-free control. By way of example, suitable sources are supplied by Micor GmbH, Advanced Photonics Technologies AG (Adphos), or Lambda Technology. An important factor for the efficient use of the NIR radiation is that a specific method with high energy density is used for thermal activation of the film.

Another method for thermal activation can use electromagnetic radiation in the radio frequency range (from 30 to 100 MHz) or in the microwave radiation range (from 400 MHz to 3 GHz).

For particularly efficient thermal activation via radio frequency radiation or microwave radiation on the film surface it can be necessary to incorporate a high-efficiency absorber for the electromagnetic radiation either into the film or into any primer layer to be applied. Nano-scale particles with ferromagnetic, ferrimagnetic, superparamagnetic, or piezoelectric properties are particularly suitable for this purpose, because when they are present in the film layer or in the primer layer the extent to which the film becomes heated on exposure to even low-power sources is so great that the surface is particularly well suited to adhesive bonding. Particularly suitable nano-scale absorbers are disclosed by way of example on pages 7 to 9 of WO 02/12409 (the counterpart U.S. application being published as US 2003-0168640).

In another method for thermal activation of the film surface, introduction can be subsequent, i.e., take place after the attaching or lamination of the surface film to the molding. In this type of procedure, any of the forms of heat introduction can be used, i.e., the abovementioned incident radiation via electromagnetic radiation in the form of NIR radiation, HF radiation in the radio frequency range, or microwave radiation, or—in less preferred embodiments—via normal convection or conventional long-wave IR radiation. In the case of subsequent introduction of heat, the introduction of heat here may be discontinuous, but preferably continuous.

In all of the forms of thermal activation, the surface temperature of the surface film—in particular of the side facing toward the adhesive—should reach the region of the glass transition temperature of the film polymers during the activation process, in order to achieve ideal adhesive bonding.

Suitable hot-melt adhesives for the adhesive bonding of the surface films by the inventive process are in principle a wide variety of hot-melt adhesives, preference being given to the reactive polyurethane hot-melt adhesives such as those marketed by way of example with the trade name “Macroplast QR” or “Purmelt” by Henkel KGaA.

Modified reactive hot-melt adhesives such as those forming the subject matter of DE 10149142.5 (the PCT counterpart of which is WO 03/031490), are in particular suitable for particularly long-lasting adhesive bonding of the (meth)acrylate-based surface films. The acrylate-modified hot-melt adhesives disclosed in WO 99/28363 are also suitable.

The moldings laminated by the inventive process may be used as doors, facade elements, door frames and window frames, or as components in the construction of furniture.

The invention will be described below using some basic experiments, but the selection of the examples is not intended to restrict the scope of the subject matter of the invention. They are merely models demonstrating the mode of action of the inventive lamination process, in particular with reference to its ease of operation and the adhesive performance of the adhesive bond. The hot-melt adhesive may be applied conventionally by spray application, or with the aid of application rollers, doctors, and the like.

### EXAMPLES

Lamination Experiments on PVC Window Profiles

The reactive hot-melt adhesive PURMELT QR 5401 from Henkel was used for the adhesive bonding of a multilayer decorative window film based on a pigmented acrylic film with transparent, colorless acrylic/polyvinylidene fluoride coextrusion film as surface layer (FAST3, Renolit) to a standard PVC window profile. The acrylate side of the decorative film was used as the adhesive-bonding side. The adhesive bonding took place on a standard profile wrapping machine, Friz, and the PVC profile here was pretreated with 6-B-23 solvent-containing primer from Henkel Dorus. The doctor gap on the wrapping machine was 50 μm, the hot-melt adhesive temperature was 130° C., and the temperature of the PVC profile was 55° C. The peel strength of the adhesive bond was checked after 3 hours, 1 day, and 7 days of storage under, standard conditions of temperature and humidity, and also after ageing (7 days, 70° C., involving water contact). The results are given in the table below.

| | | Temp. | Temp. | | | Peel | Peel | Peel |
|---|---|---|---|---|---|---|---|---|
| | | upstream | downstream | Temp. | | strength | strength | strength |
| | | of NIR | of NIR | at | Post- | after | after | after |
| | Preheating | source | source | gap | treatment | 3 h | 24 h | 7 d |
| Example | of film | ° C. | ° C. | ° C. | of specimen | N/20 mm | N/20 mm | N/20 mm |
| 1 | none | — | — | 70 | none | 14 | 28 AF | 50 AF |
| (comparison) | | | | | | | | |
| 2 | none | — | — | 70 | 30 min/60° C. | 16 | 46 AF | 55 AF |
| 3 | none | — | — | 70 | 30 min/80° C. | 16 | 70 AF | 80 FT |
| 4 | with NIR | 61 | 80 | 68 | none | 25 | 59 AF | 78 FT |
| 5 | with NIR | 74 | 83 | 72 | none | 25 | 54 AF | 82 FT |
| 6 | with NIR | 92 | 86 | 77 | none | 25 | 61 AF | 84 FT |
| 7 | with NIR | 46 | 58 | 55 | none | 14 | 28 AF | 46 AF |

AF = Adhesion fracture with respect to film
FT = Film tears
NIR equipment: MICOR

The procedure in example 1 (comparison) was that of the prior art, and only the profile was preheated. In examples 2 and 3 thermal post-treatment took place after the adhesive bonding process at 60° C. or 80° C. In examples 4 to 6 the film was preheated as it passed through the MICOR NIR equipment and in-line-coated with adhesive and then wrapped. Advanced rate of film during in-line activation and adhesive application: 15 m/min, distance of film from NIR source: 20 mm.

The examples show that both the subsequent thermal activation and the in-line activation by means of NIR bring about a marked improvement in peel strength over the comparison. Experiment 7 shows that if too little energy is introduced the results achieved are not ideal. All of the profiles adhesive-bonded by the inventive process exhibited high peel values, mainly with (desirable) tearing of the film, after 7 days of storage, and also in particular after ageing.

1. A process for laminating a surface film comprising at least one polymer with a glass transition temperature above 50° C. to a molding comprised of a material selected from the group consisting of polyvinyl chloride (PVC), polypropylene, acrylonitrile-butadiene-styrene copolymers (ABS), wood, and aluminum, said process comprising:
a) thermally activating the surface film via heating with electromagnetic radiation;
b) applying a hot-melt adhesive to a surface of the surface film; and
c) attaching the surface film to a surface of the molding.

2. The process as claimed in claim 1, additionally comprising pretreating said surface of the surface film with at least one cleaning agent before step a).

3. The process as claimed in claim 1, wherein the electromagnetic radiation used comprises IR radiation.

4. The process as claimed in claim 1, wherein the electromagnetic radiation used comprises radio frequencies in the range from 30 to 100 MHz.

5. The process as claimed in claim 1, wherein the electromagnetic radiation used comprises microwaves in the frequency range from 400 MHz to 3 GHz.

6. The process as claimed in claim 1, wherein thermal activation of the surface film is carried out after attaching the surface film to the molding.

7. The process, as claimed in claim 1, wherein the hot-melt adhesive used comprises a reactive polyurethane adhesive.

8. The process as claimed in claim 1, wherein thermal activation of the surface film is carried out before attaching the surface film to the molding.

9. The process as claimed in claim 1, wherein prior to step b) said surface of said surface film is subjected to corona treatment.

10. The process as claimed in claim 1, wherein prior to step b) a primer is applied to said surface of said surface film.

11. The process as claimed in claim 1, wherein prior to step c) said surface of said molding is treated with a cleaning agent.

12. The process as claimed in claim 1, wherein a primer is applied to said surface of said molding prior to step c).

13. The process as claimed in claim 1, wherein at least one volatile constituent is applied to said surface of said molding and said at least one volatile constituent is removed by drying prior to step c).

14. The process as claimed in claim 1, wherein said surface film and said molding are pressed together in step c).

15. The process as claimed in claim 1, wherein said surface of said molding is treated by at least one method selected from the group consisting of corona treatment and flame treatment prior to step c).

16. The process as claimed in claim 1, wherein said electromagnetic radiation comprises near-infrared (NIR) radiation in the wavelength range from 0.7 to 1.5 μm.

17. The process as claimed in claim 1, wherein said surface film is a single layer film.

18. The process as claimed in claim 1, wherein said surface film is a multilayer film.

19. The process as claimed in claim 1, wherein said surface film is comprised of at least one poly(meth)acrylate.

20. The process as claimed in claim 1, wherein said at least one polymer has a glass transition temperature from 60 to 100° C.

21. The process as claimed in claim 1, wherein said surface film comprises at least one high-efficiency absorber for the electromagnetic radiation in the form of nano-scale particles.

22. The process as claimed in claim 1, wherein a primer layer is present on said surface of said surface film and said primer layer comprises at least one high-efficiency absorber for the electromagnetic radiation in the form of nano-scale particles.

23. A process for laminating a surface film comprising at least one poly(meth)acrylate with a glass transition temperature from 60° C. to 100° C. to a molding comprised of polyvinyl chloride (PVC), said process comprising:
a) applying a reactive polyurethane hot-melt adhesive to a surface of the surface film; and
b) attaching the surface film to a surface of the molding, said surface film being pressed onto said surface of said molding;
wherein said surface film is thermally activated via heating with near-infrared radiation.
